(19) United States
(12) Patent Application Publication
(10) Pub. No.: US 2003/0113178 A1
(43) Pub. Date: Jun. 19, 2003

(54) Method and device for making a relief surface

(75) Inventor: Vladimir Stephanovich Podmiglazov, Ozersk (RU)

Correspondence Address: KINNEY & LANGE, P.A., THE KINNEY & LANGE BUILDING, 312 SOUTH THIRD STREET, MINNEAPOLIS, MN, 55415-1002, US

(73) Assignee: Charlin IBS LLC, Rochester, MN

(21) Appl. No.: 10/324,274

(22) Filed: Dec. 19, 2002

Related U.S. Application Data
(63) Continuation-in-part of application No. PCT/RU02/00309, filed on Jun. 26, 2002.

(30) Foreign Application Priority Data
Jun. 26, 2002 (WO) PCT/RU02/00309
Jul. 2, 2001 (RU) 2001117990

(51) Int. Cl. B23C 1/00

(52) U.S. Cl. 409/132

(57) ABSTRACT

Method and device for making a relief surface to improve surface quality. The method is that, simultaneously with the main element's movement in two mutually perpendicular directions, it is being moved in horizontal and vertical planes along various paths. The device contains horizontal and vertical supports installed on a motionless chassis and a program controlled mechanisms with a position regulating drive to set the stock width.

### CROSS-REFERENCE TO RELATED APPLICATION(S)

The present application is a continuation-in-part of PCT/RU 02/00309, filed Jun. 26, 2002, entitled METHOD AND DEVICE FOR MAKING A RELIEF SURFACE”, which claims priority from Russian patent application No. RU 2001117990 filed Jul. 2, 2001, now Russian Patent No. 2,181,669.

### BACKGROUND OF THE INVENTION

The invention pertains to ornamental art and in particular to a method of decorating articles to create relief images.

There is an existing method of creating relief surfaces where stock is supplied lengthwise and its surface is processed by a driven cutting element that simultaneously moves by means of a set program in two mutually perpendicular directions along the stock surface.

The device for making a relief surface described there has an installed on the motionless foundation: mobile frame and a drive mechanism to supply stock that are program controlled, and main element including cutters installed on the mobile frame (see RU patent 2094238, B 44 B 3/00, 27.10.1997—analog and prototype).

A disadvantage of the existing method is that the device, in which the method of plane-parallel motion of the working element is used, has low productivity and low processing speed because of the complexity and the weight of the moving parts. The sluggishness and the heavy load on the actuator's elements results in poor quality of an achieved relief.

### BRIEF SUMMARY OF THE INVENTION

The technical achievement of the invention is the improved quality of the relief surface and the possibility of creating an infinite number of pictures and patterns.

In this method it is accomplished by a simultaneous movement of the driven cutting element in two mutually perpendicular directions and by its movement in horizontal and vertical planes along curves with various trajectories and by making free oscillating and arc-like movements while being constantly balanced and steadied against the vertical and horizontal axes.

The device accomplishes this by means of:

Horizontal and vertical supports installed on a motionless chassis and a program controlled mechanism that forms the width of the stock and a drive to regulate its position,

a mechanism to form the shape of stock edges with a drive to regulate its position,

hold-down mechanisms,

a chain driven spring-loaded controlled mechanism, kinematically connected to spring-loaded feeding rollers to move stock,

a device installed on a horizontal support to move the mobile frame horizontally,

a device installed on a vertical support to move the mobile frame vertically and a device to move horizontal and vertical support pillars at an angle around the vertical axis for five-axis processing of the stock where the main element, or cutting tool installed on the free end of the mobile frame is a cutter shaft connected to the electric motor by (for example) a belt transmission, or an end mill, or a laser,

a holder with cutters to form the width of the stock connected to the electric motor that can adjust and lock position,

figure cutters to form the shape of the stock edges that contain a holder connected to the electric motor that can adjust and lock position,

hold-down mechanisms installed before and after the cutting tool that contain spring-loaded rollers, mounted so that they can self adjust to move stock of various thicknesses,

spring-loaded feeding rollers to move the stock that contain top and bottom bearing support pillars, holding shafts with chain sprockets of the chain mechanism and leading and holding-down rollers located on them that can provide stable hold-down for the surface of stock of various thicknesses, where bottom bearing supports pillars can adjust and lock position in relation to the top bearing support pillars,

a device for horizontal movement of the mobile frame that contains a ball-and-screw connected to the motor by a pivot ball-jointed link at the free end that has the ability to affect the mobile frame in the horizontal plane,

a device for vertical movement of the mobile frame that contains a ball-and-screw connected to the motor by a pivot ball jointed link at the free end that has the ability to affect the mobile frame in the vertical plane where the mobile frame is installed on a motionless chassis on separate vertical and horizontal axes to provide for the movement of the cutting tool in the horizontal and vertical planes along curves with various trajectories and to provide oscillating arc-like movements of various patterns and to provide for the frame's active balanced state in relation to the vertical and horizontal axes where the drive of the mechanism to feed the stock is made so that it can regulate the speed of stock feeding to apply infinite numbers of patterns.

The shape of the stock cross-section can be elliptical, circular, hexagonal, square, octagonal, rectangular, etc.

Stock can be flat or disk shaped and secured on a rotary table. In this case a stock feeding is a revolving of the stock on its axis.

The cutting edge of the figure cutters to form stock edges can be (for example):

a rectilinear section, opposing arc-like sections and a rectilinear section with the smaller dimension lengthwise width that are smoothly linked, or

arc-like sections and a linear section with the reduced lengthwise width that are smoothly linked, or

linear terraced sections that are smoothly linked, or

symmetrically located linear sections along the longitudinal axis with alternating pits.

The cutting edge of the one-piece figure cutters installed on the cutter shaft contains (for example):

linear and serrated sections on one side and linked lengthwise arc-like, linear and serrated sections on the opposite side, or

linked sinusoidal sections on one side and linked linear and arc-like sections on the opposite side.

The cutting edge of the sectional figure cutters installed on the cutter shaft contain (for example):

a convex section with an overhang on the face plane, or

a shifted convex section, or

a triangular section with the teeth at the top, or

a convex slanted section, or

a sinusoidal section with concave and linear sections.

Wood, stone, metal, plastic, foam, and other materials can be used as stock material.

### BRIEF DESCRIPTION OF THE DRAWINGS

The essence of the invention is explained in the drawings where:

FIG. 1 shows a mounted device ready to make a relief surface, side view,

FIG. 2—feeding spring-loaded rollers to move stock,

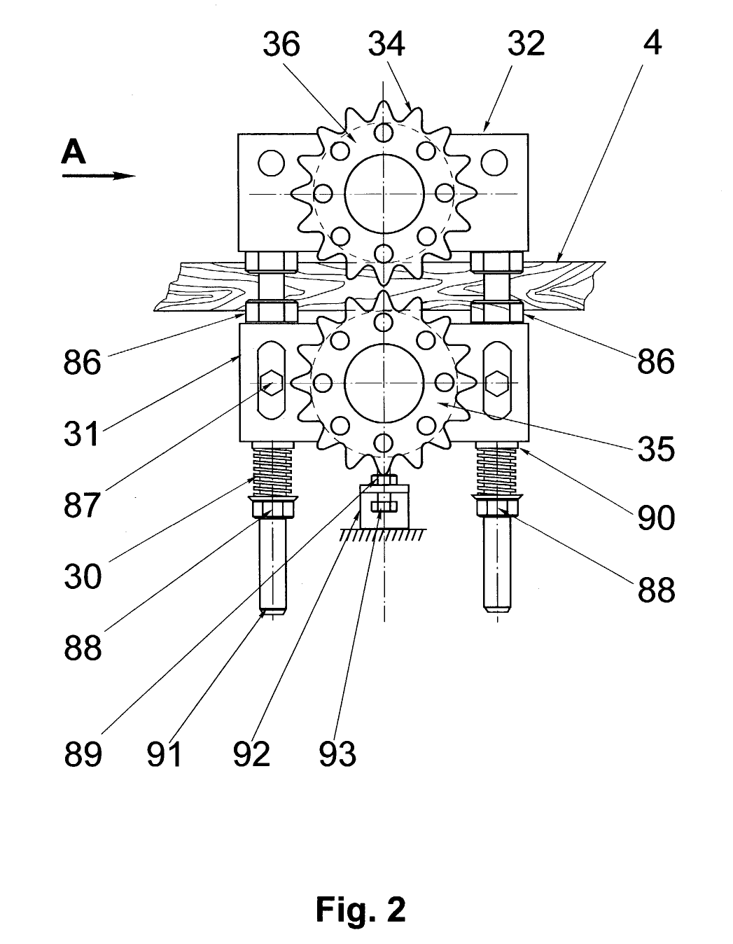

FIG. 3—view A at FIG. 2,

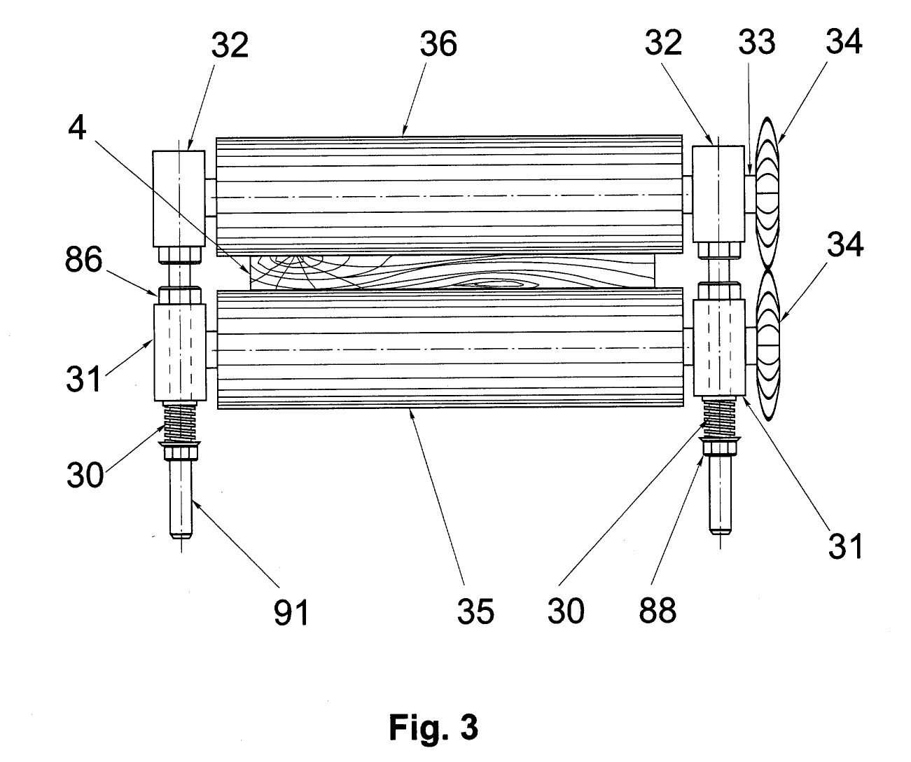

FIG. 4—view B at FIG. 1,

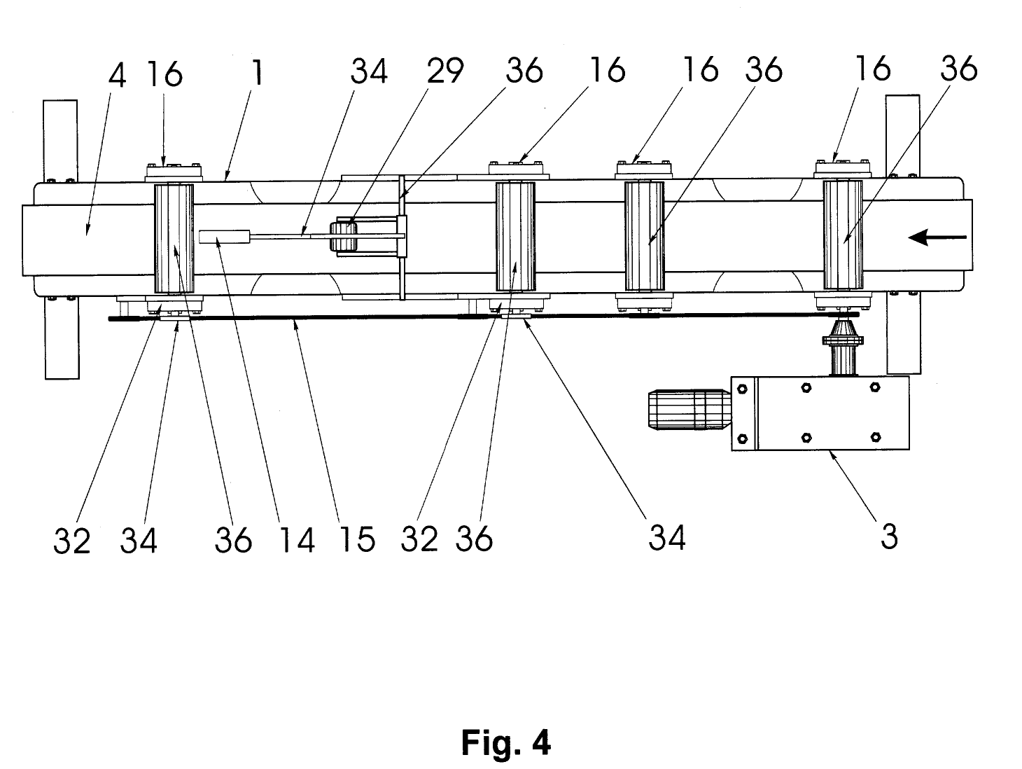

FIG. 5—a partial device from FIG. 1,

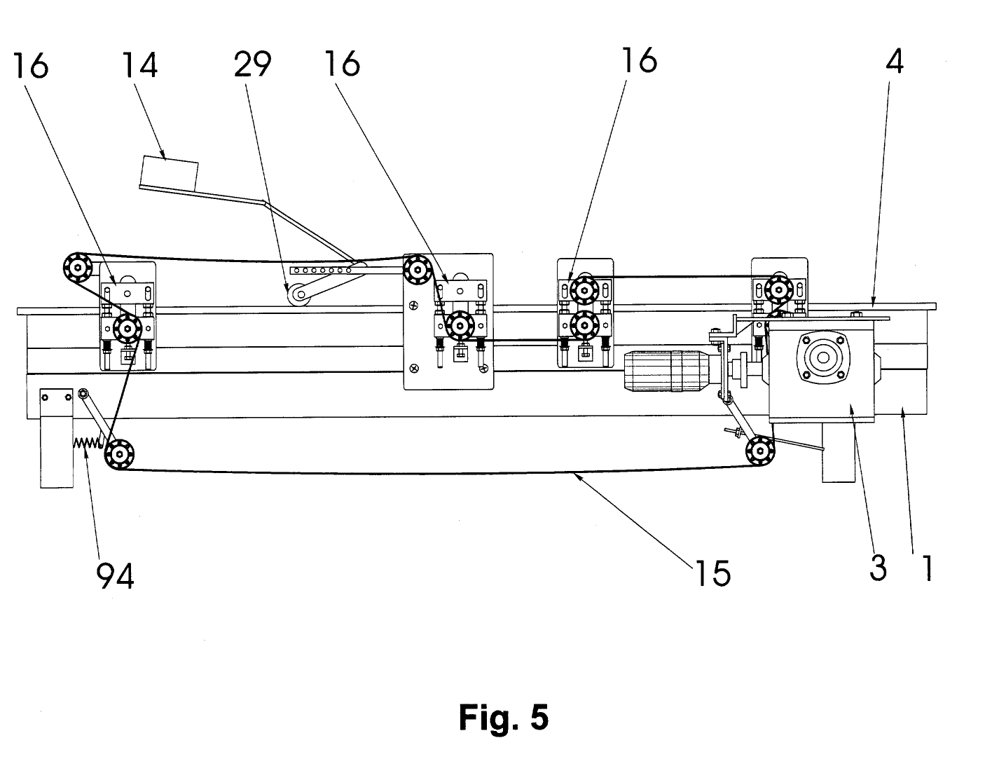

FIG. 6—the mechanism to form the shape of stock edges,

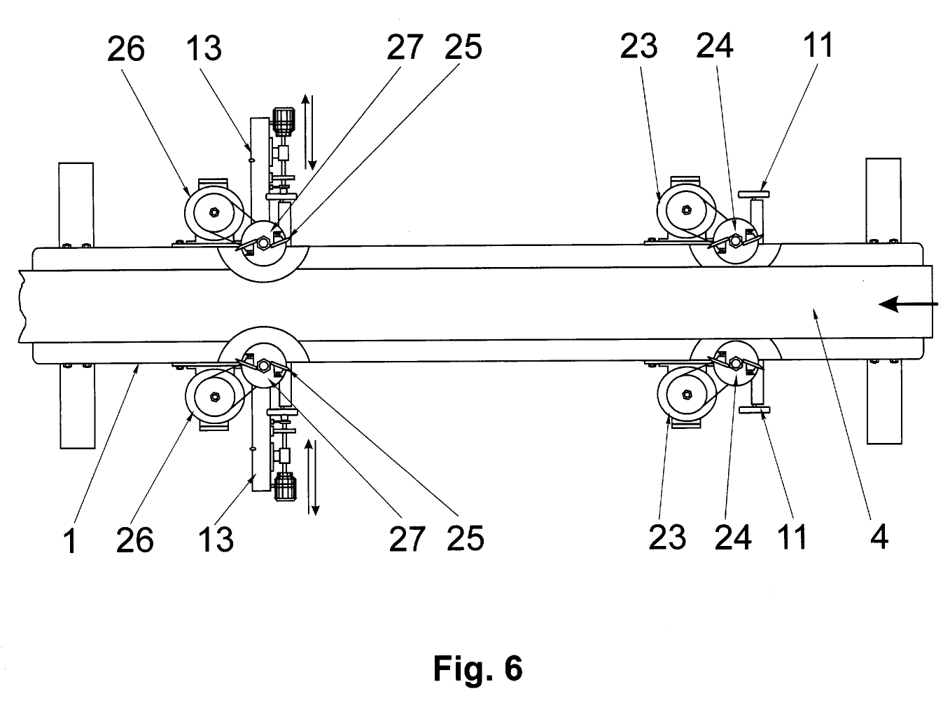

FIG. 7—horizontal movement of the cutting tool,

FIG. 8—vertical movement of the cutting tool,

FIG. 9—vertical movement of the cutting tool—an end mill,

FIG. 10—the device for vertical movement of the mobile frame,

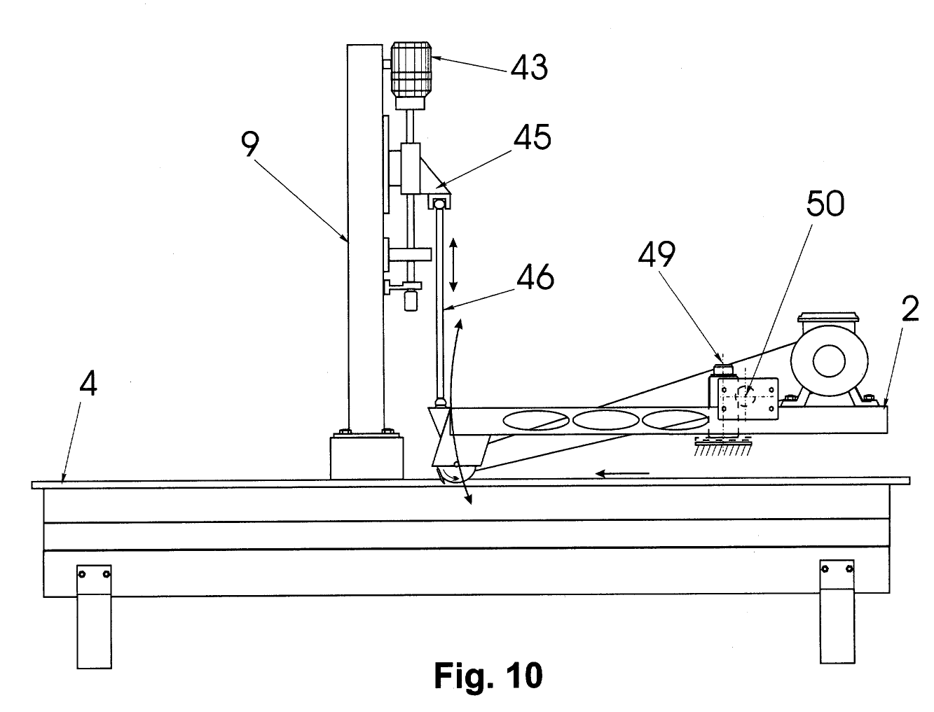

FIG. 11—the device for horizontal movement of the mobile frame,

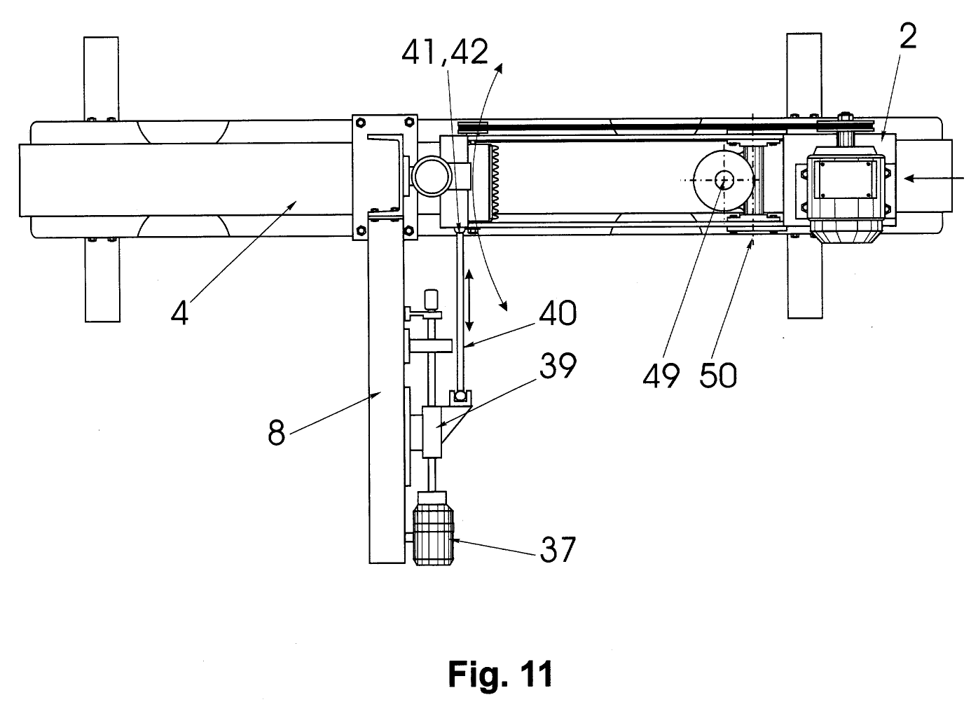

FIG. 12—a diagram of the cutting tool's movement in the active balanced state,

FIG. 13—the mechanism to form the stock width,

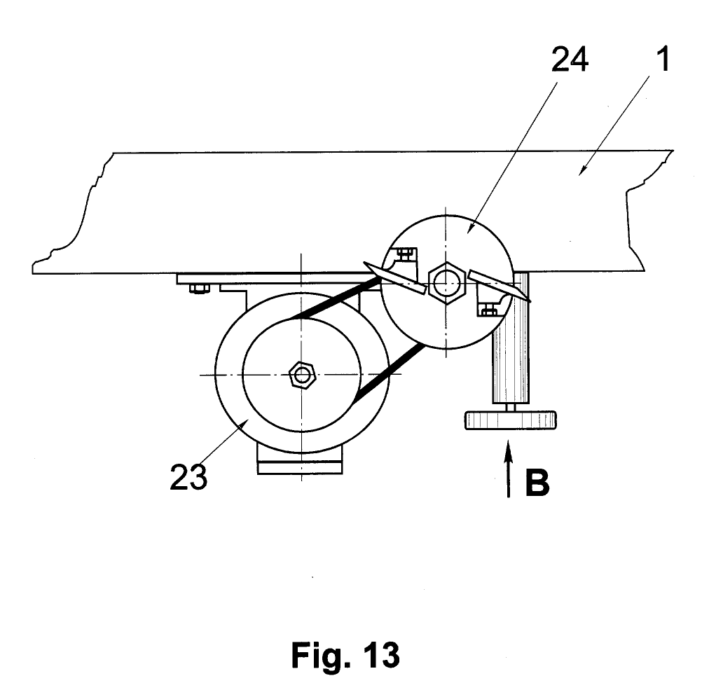

FIG. 14—view B at FIG. 13,

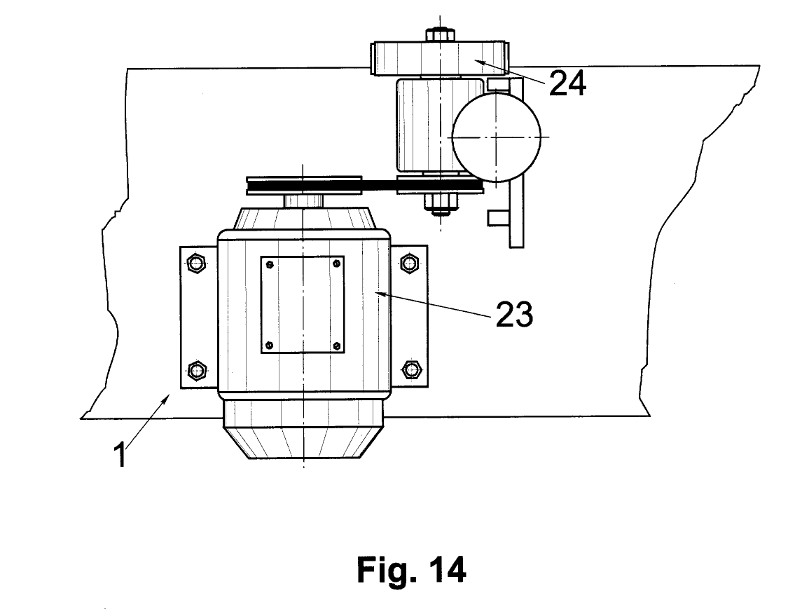

FIG. 15—cutting edge of the figure cutters to form the stock edges,

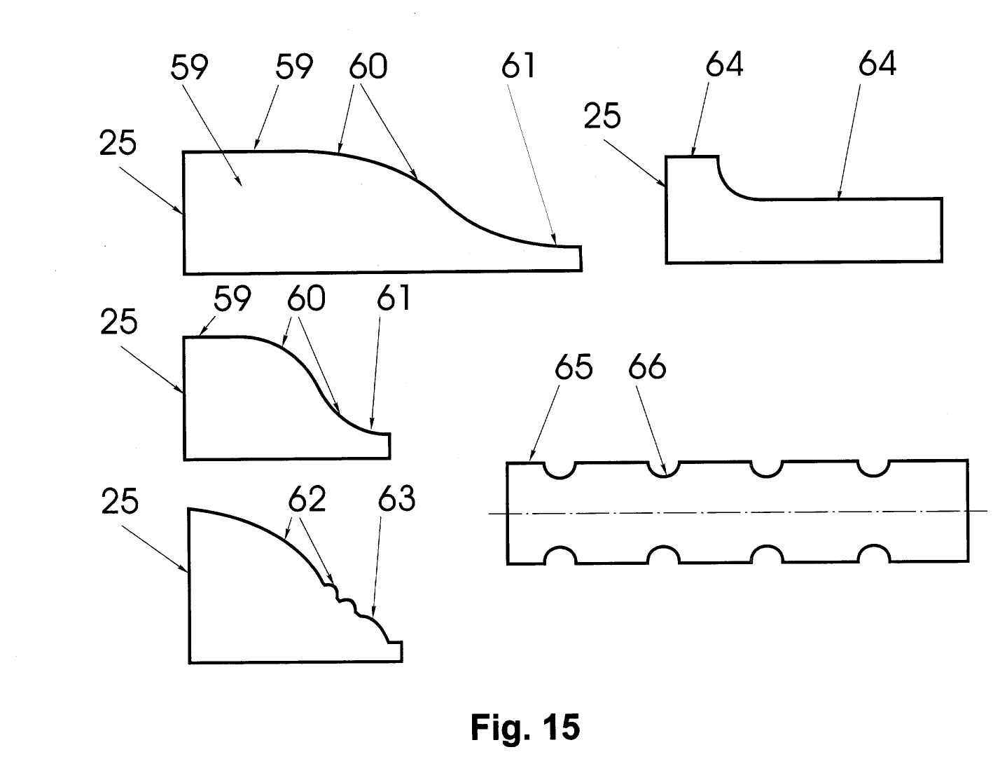

FIG. 16—cutting edge of the one-piece figure cutters installed on the cutter shaft,

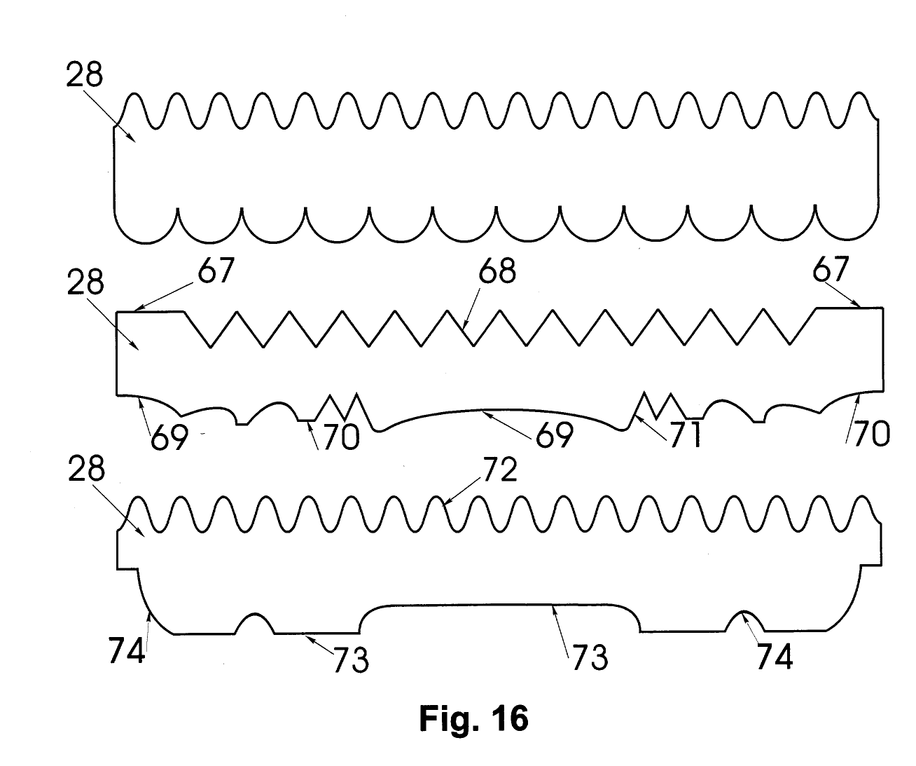

FIG. 17—cutting edge of the sectional figure cutters installed on the cutter shaft,

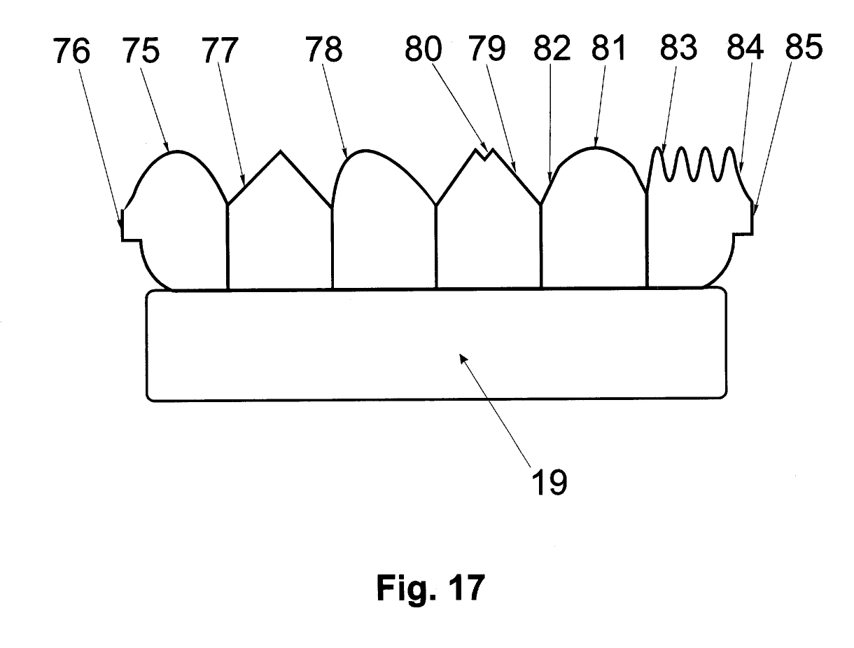

FIG. 18—view from the top of the device to process circular flat stock,

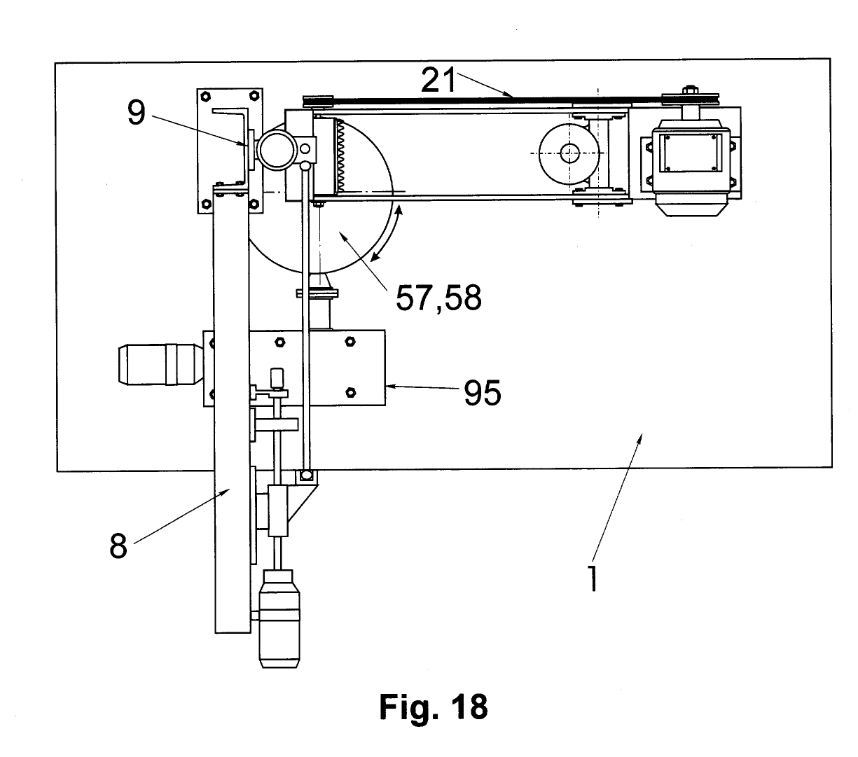

FIG. 19—cross-section shapes of the stock,

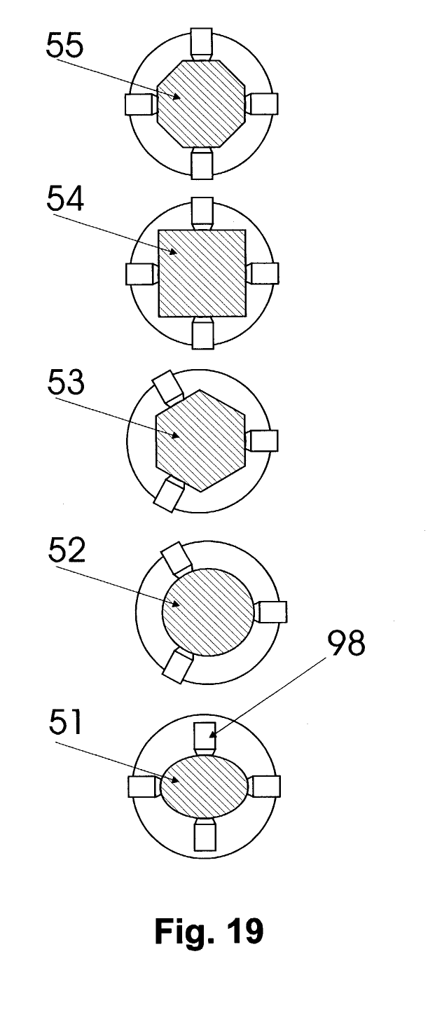

FIG. 20—relief made on cylindrical bar-shaped stock,

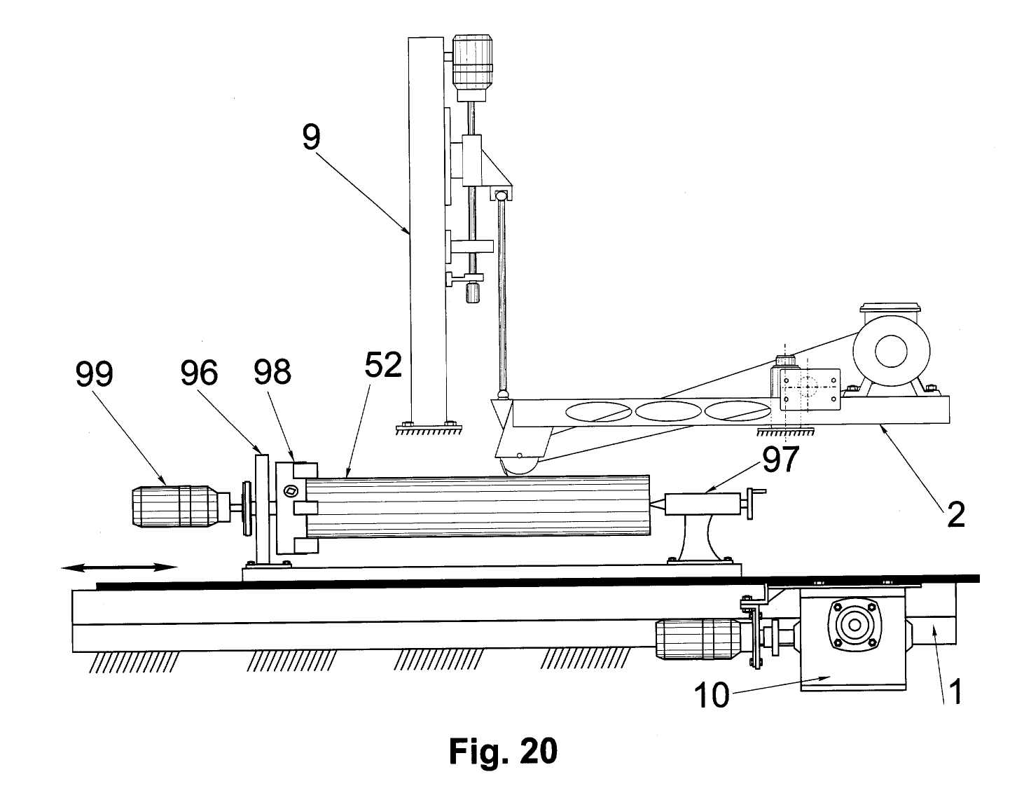

FIG. 21—same as FIG. 20, using five-axis process.

FIG. 22—is a perspective view of the device of the present invention.

While the above-identified drawing figures set forth a preferred embodiment, other embodiments of the present invention are also contemplated, some of which are noted in the discussion. In all cases, this disclosure presents the illustrated embodiments of the present invention by way of representation and not limitation. Numerous other minor modifications and embodiments can be devised by those skilled in the art which fall within the scope and spirit of the principles of this invention.

### DETAILED DESCRIPTION

The device to make relief surface contains installed on the motionless chassis 1 and a program controlled driven mobile frame 2, a drive 3 of the mechanism to feed the stock 4 installed on the mobile frame 2 of the driven cutting tool 6 that includes a cutter shaft 19 and figure cutters 28.

The device consists of:

installed on the motionless chassis 1 horizontal 8 and vertical 9 support pillars and a program controlled mechanism 10 to form the width of the stock 4 with the drive 11 to adjust its position,

a mechanism 12 to form the shape of the stock edges 4 with the drive 13 to adjust its position,

hold-down mechanisms 14,

regulated spring-loaded chain mechanism 15, kinematically connected with mechanisms 16 of the spring-loaded feeding rollers to move stock 4,

an actuator 17 installed on the horizontal 8 support pillar to move the mobile frame 2 horizontally

and a device 18 installed on the vertical 9 support pillar to move the mobile frame 2 vertically.

Cutting tool 6 is installed on the free end of the mobile frame 2 and can be a cutter shaft 19 connected to the electric motor 20 by means of (for example) a transmission belt 21, or an end mill 22, or a laser (not shown).

Mechanism 10 to form the stock 4 width contains a connected to the electric motor 23 a holder 24 of the cutters providing for the possibility to adjust and lock position.

Mechanism 12 to form the shape of the stock 4 edges contains a holder 27 of the figure cutters 25 connected to the electric motor 26 providing for the possibility to adjust and lock position.

Hold-down mechanisms 14 installed before and after the cutting tool 6 and contain spring-loaded rollers 29 that have the ability for self-adjustment for the movement of stock 4 of various thicknesses.

Mechanisms 16 of the spring-loaded feeding rollers to move stock 4 contain spring-loaded 30 bottom 31 and top 32 mounts with constant tension, bearing support axles 33 with chain sprockets 34 of the chain mechanism 15 and located on them leading 35 and holding down 36 rollers installed to provide for stable hold-down to the stock 4 surface of various stock thicknesses. Bottom support pillars 31 are built so that they can adjust and lock position relating to the top support pillars 32.

Actuator 17 for horizontal movement of the mobile frame 2 contains a ball-joint 38 and a ball-and-screw 39 with the link 40 connected to the servo-motor 37 that carries element 42 on the free end via a ball-joint 41 to affect the mobile frame 2 in the horizontal plane. The computer controlled actuator 17 controls pivoting of the support arm 2 about the second pivot axis 49. Thus, the support arm 2 is further pivotable about a generally vertical axis 49 for lateral positioning.

Actuator 18 for vertical movement of the mobile frame 2 contains a ball-joint 44 and a ball-and-screw 45 with the link 46 connected to the servo-motor 43 that carries element 48 at the free end via a ball-joint 47 to affect the mobile frame 2 in the vertical plane. The actuator 18 has a computer controlled motor 43 which controllably rotates a shaft. A couple 45 is threadedly received on the shaft for linear movement along the shaft, and a link 46 connects the couple to the support arm 2 for vertical positioning of the cutting tool 6.

Mobile frame 2 is installed on a motionless chassis 1 on separated vertical 49 and horizontal 50 axes to allow the cutting tool 6 to move in horizontal and vertical planes along the curves with various trajectories to provide for multi-axis oscillating arc-like movements and to allow mobile frame 2 to remain in the active balanced state in relation to the vertical 49 and horizontal 50 axes.

The drive of mechanism 3 to supply stock 4 is constructed so that it can adjust the speed of stock supply to apply an unlimited number of patterns. The cross-section of the stock can be elliptical 51, circular 52, hexagonal 53, square 54, octagonal 55, rectangular 56 or others. Stock 4 can be flat 57 or disk 58 shaped and secured on a rotary table.

Generally, the powered contour shaping machine has cutting tool 6 which is movable for material removal. A motor 20 is coupled to the cutting tool 6 for powering the cutting tool 6 for material removal. A support arm 2 supports the cutting tool 6 and the motor 20. The motor 20 is coupled to the cutting tool 6 with a belt 21 or chain.

The support arm 2 is pivotable about a generally horizontal pivot axis 50 and about a generally vertical axis 49. The cutting tool 6 on the support arm 2 has a cutting tool moment arm on a first side of the pivot axis 50. The motor 20 on support arm 2 has a motor moment arm on a second, opposing side of the pivot axis 50. The cutting tool moment arm and the motor moment arm are selected on 30 the support arm 2 so the motor 20 gravitationally balances and offsets the cutting tool.

The powered contour shaping machine has a cutting tool 6 for material removal, a pivoting support arm 2, a first and a second computer controlled actuator 17 and 18, and a powered stock feed apparatus 3. The support arm 2 pivots about a first pivot axis 50 and about a second pivot axis 49 that is generally perpendicular to the first pivot axis 50. The support arm 2 supports a counterweight 20 on a second, opposing side of the first pivot axis 50 so the counterweight 20 gravitationally offsets the cutting tool 6. The first computer controlled actuator controls pivoting of the support arm 2 about the first pivot axis 50. The second computer controlled actuator controls pivoting of the support arm 2 about the second pivot axis 49. A powered stock feed apparatus 3 moves stock 4 relative to the cutting tool 6. In one embodiment, the cutting tool 6 is a laser.

The cutting edge of the figure cutters 25 to form stock edges of the stock 4 is (for example):

a rectilinear section 59, opposing arc-like 60 sections and a rectilinear 61 section with the smaller dimension lengthwise width that are smoothly linked, or

arc-like 62 section and a linear 63 section with the reduced lengthwise width that are smoothly linked, or

linear 64 terraced sections smoothly linked, or

symmetrically located linear 65 section along the longitudinal axis with alternating pits 66.

Cutting edge of the one-piece figure cutters 28 installed on the cutter shaft 19 contains (for example):

linear 67 and serrated sections 68 on one side and linked lengthwise arc-like 69, linear 70 and serrated 71 sections on the opposite side, or

linked sinusoidal sections 72 on one side and linked linear 73 and arc-like 74 sections on the opposite side.

Cutting edge of the sectional figure cutters 28 installed on the cutter shaft 19 contains (for example):

a convex 75 section with an overhang 76 on the face plane, or

a shifted convex section 78, or a triangular 79 section with the teeth 80 at the top, or

a convex 81 slanted 82 section, or a sinusoidal 83 section with concave 84 and linear 85 sections.

Wood, stone, metal, plastic, foam, and other materials can be used as stock 4.

Feeding mechanism to move stock contains spring-loaded rollers 35 and 36, a nut 86, bolts 87, nuts 88, 89, washer 90, bolts 91, anchor angles 92, bolts 93, and springs 94. The feeding mechanism or powered stock feed apparatus 3 moves stock 4 relative to the cutting tool 6.

There is a rotating mechanism 95, spindle 96, center 97, clamps 98 for the stock, motor 99 and device 100 for angular rotation of the horizontal and vertical pillars around the vertical axis for 5-axis processing, that contains a ball-screw and the link with a ball-joint connected to the servo-motor. As an example, it can be used to make spiral patterns on the cylindrical surface.

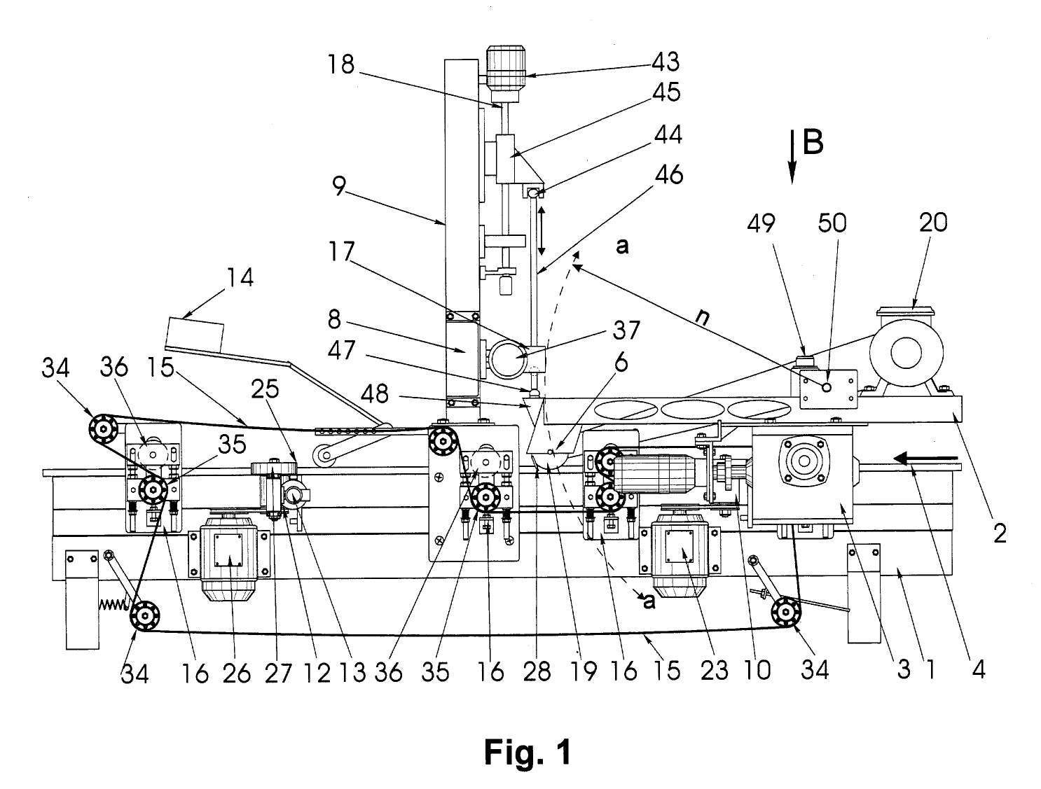

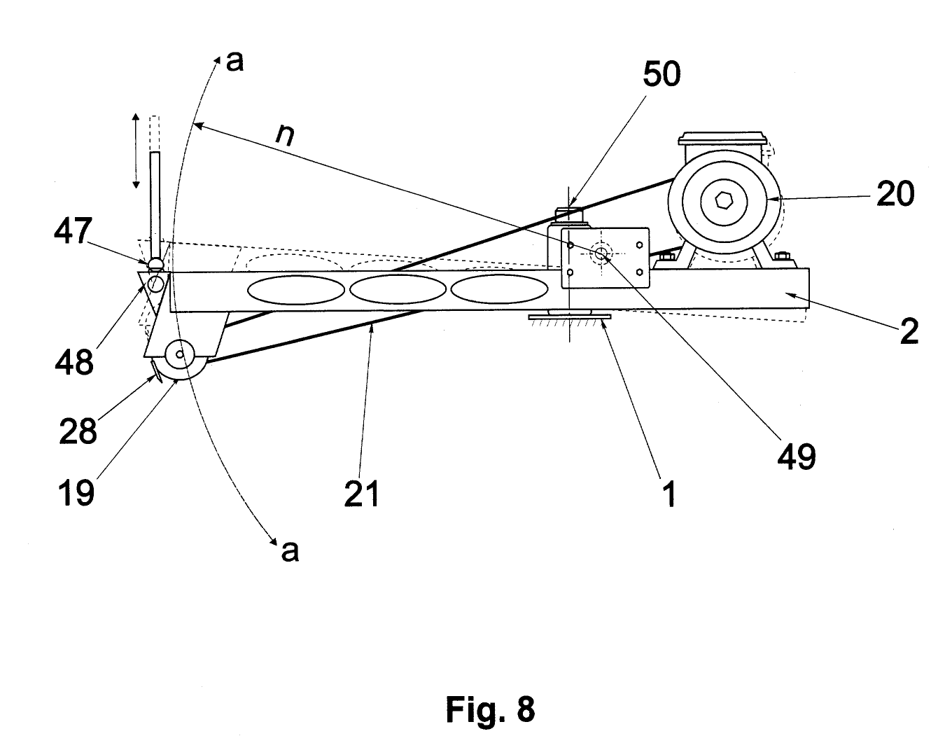

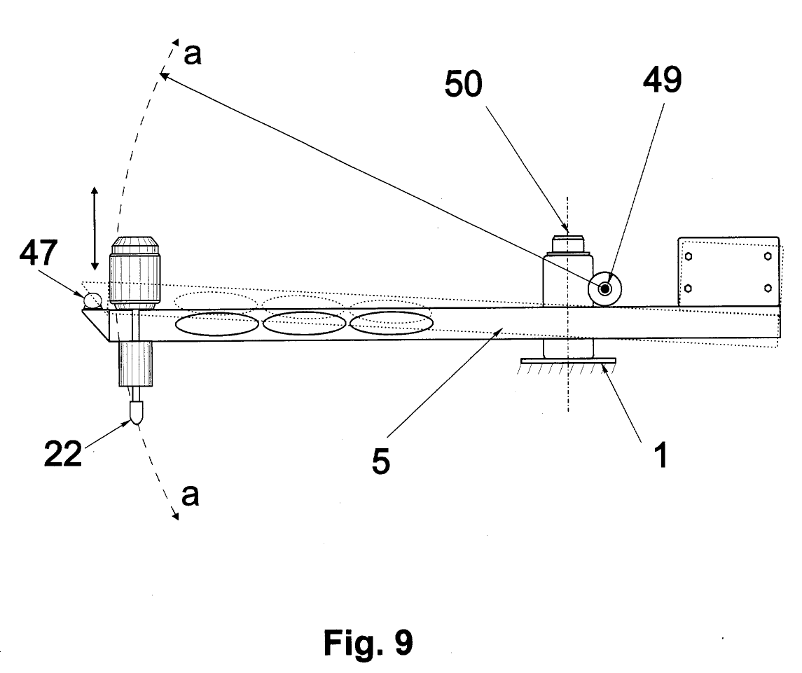

FIGS. 1, 8 and 9 show movement of the cutting tool 6 or end mill 22 along the arc “a-a” with the radius “n”.

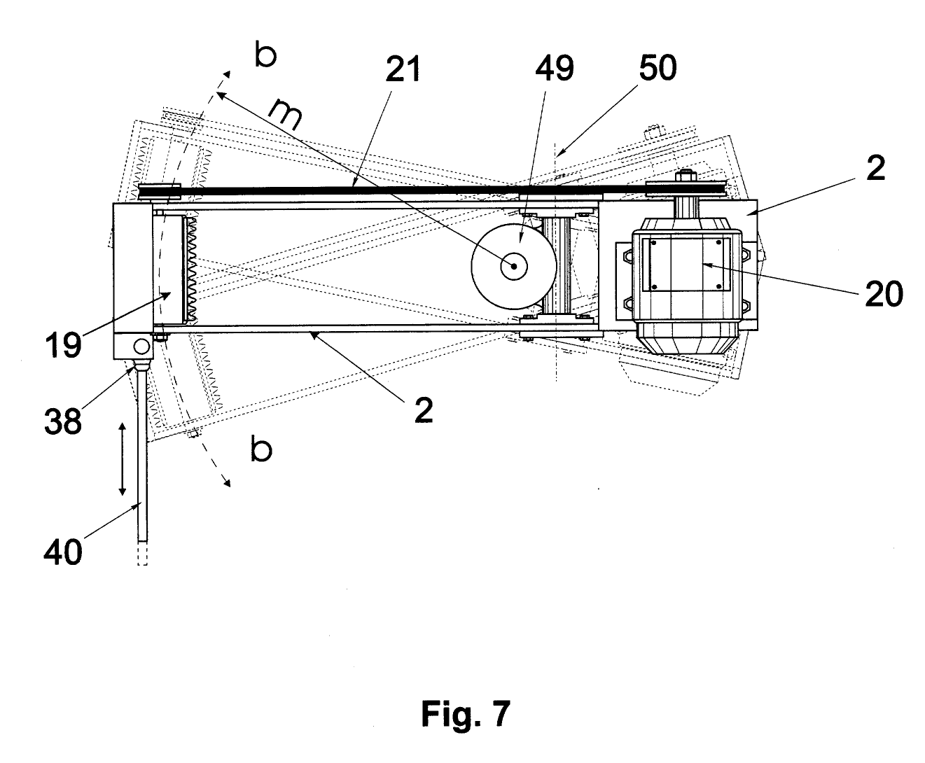

FIG. 7 shows movement of the cutting tool 6 or end mill 22 along the arc “a-a” with the radius “m”.

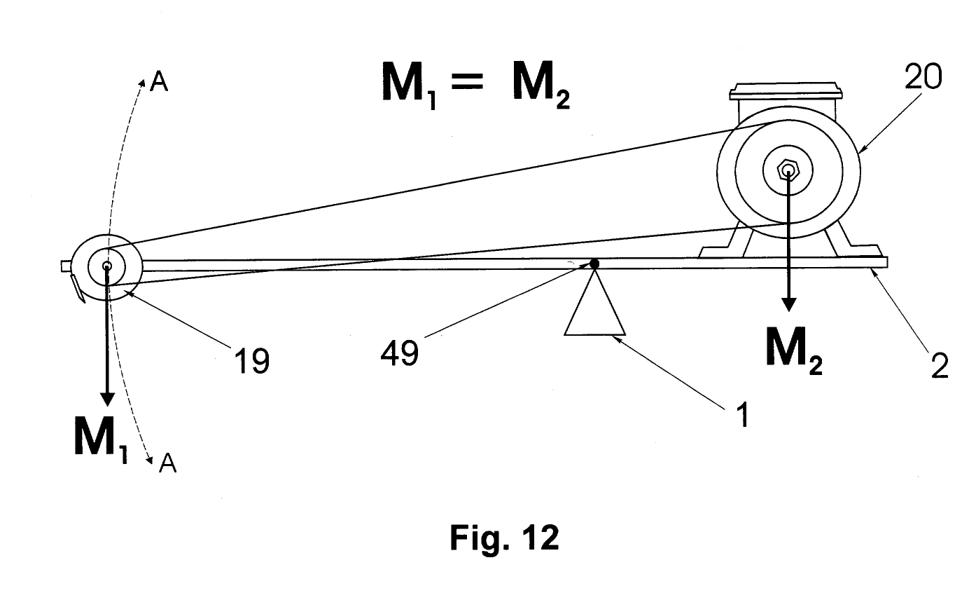

FIG. 12 shows the balanced state of the cutting tool 6 when torques are equal M1=M2.

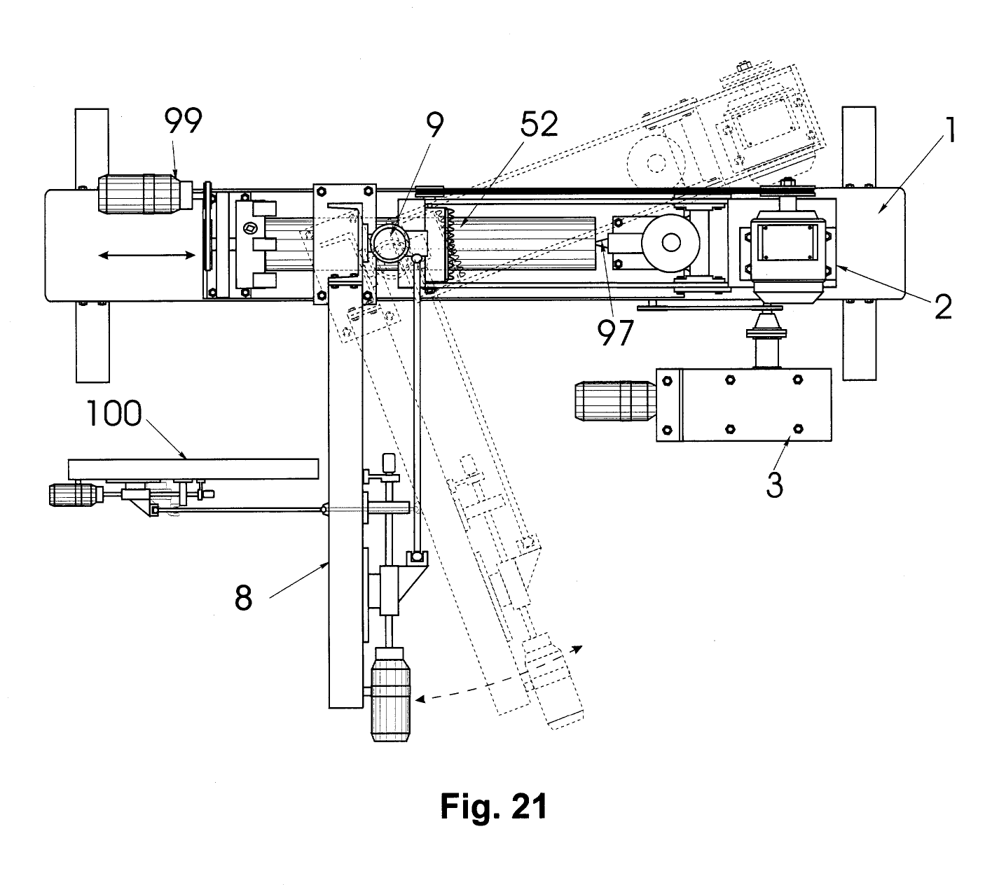

With respect to FIG. 21, in order to make, for instance, a spiral pattern on the cylindrical surface, the material has to move in a longitudinal direction and simultaneously rotate around its axis. Thus the cutter shaft should be revolved with an angle of the spiral. Therefore that there are two additional degrees of freedom (axis)-rotation of a material around its axis and revolving of the cutter shaft around a vertical axis. With such capabilities the machine can make spiral patterns with any angle of inclination.

The device and method to make relief surface works in the following way: Processed by means of the drive of the feeding mechanism 3 and mechanism 16 of the feeding rollers, stock 4 is fed to the working zone to the driven cutting tool 6.

The drive motor 20 rotates the cutter shaft 19 of the cutting tool 6 by means of the belt transmission 21, or an end mill rotates, or a laser head turns on. The cutter shaft 19 rotates at a high angular speed (several thousand rotations per minute).

The actuators of the horizontal, vertical and angular movements of the cutting tool 6 receive control signals from, for example, the programmable logic controller (PLC), or Computer Numerical Controller (CNC), or Industrial PC, (not shown) and constantly move the cutting tool 6 according to the program in horizontal, vertical and angular directions. The computer controls the stock feeding drive 3 that effects the stock 4 feeding speed.

Thus the invention improves the quality of the relief surface and produces an infinite number of pictures and patterns.

Industrial application.

The invention can be used to make relief patterns. Specifically, the invention pertains to ornamental art and can be used to create relief patterns on various surfaces, wooden surfaces in particular. The device consists of the horizontal shaft with cutting blades sharpened in the figure profile. The shaft rotates with high speed and simultaneously moves in the horizontal and vertical planes according to the preset order. Material is fed horizontally.

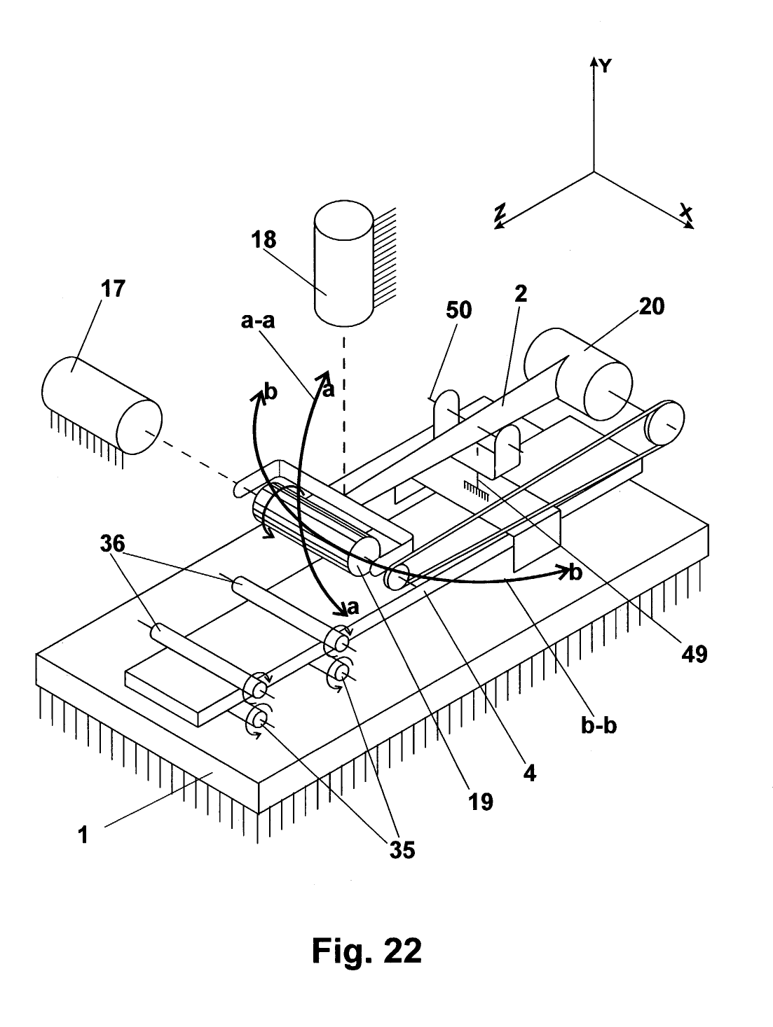

The diagram of the device is shown in FIG. 22. It contains a motionless platform and a mobile chassis with a cutter shaft located on the chassis. During the operation the material moves in the direction “Z” and the mobile chassis together with the cutter shaft moves in the planes “X” and “Y”. The material is processed along the entire width. The cutter shaft rotates with high angular speed, which provides fast processing.

The device consists of the motionless foundation 1 where the feeding mechanism 35, 36 is mounted for longitudinal motion of the material 4. The pattern is applied by means of the cutting blades sharpened in the figure profile. The cutting blades are mounted on the cutter shaft 19. The cutter shaft 19 is mounted on the end of the mobile chassis 2 that can move in two mutually perpendicular directions a-a and b-b. Movement of the chassis 2 in the given directions is accomplished by means of two actuators 17 and 18 controlled by the programmable controller or a computer. The mobile chassis 2 is oriented in the same direction as the fed material 4. The mobile chassis 2 is connected to the motionless foundation 1 by means of two hinged joints that have vertical 49 and horizontal 50 axes located in the same plane. The cutter shaft 19 and the driving motor 20 are located on opposing ends of the mobile chassis 2, i.e. on opposite sides from the hinged joints and are connected together by the mechanical transmission.

The allocation of the cutter shaft and driving motor on the mobile chassis at the opposite sides from the hinged joints provides for the static balance of the cutter shaft and driving motor and allows decreasing sluggishness (i.e. lag effect, lag, or response time) of the executive device (cutter shaft) and increasing the processing speed of the device.

The device works in the following manner: By means of the longitudinal feeding mechanism 35, 36 the processed material 4 is fed to the working zone of the cutter shaft 19. The driving motor 20 rotates the cutter shaft at a high angular speed. The drives 8 and 9 move the mobile chassis 2 along the preset path in the directions a-a and b-b.

Decorative relief pattern on the material surface is created by the figure profile of the cutter shaft and the complex path of its movement during the simultaneous feeding of the material through the working zone.

Although the present invention has been described with reference to preferred embodiments, workers skilled in the art will recognize that changes may be made in form and detail without departing from the spirit and scope of the invention.

1. The method to make a relief surface by longitudinal supply of stock and its surface processing by a driven cutting tool simultaneously moving it according to the given program in two mutually perpendicular directions along the surface of stock differs in that the cutting tool moves in two mutually perpendicular directions simultaneously moving it in horizontal and vertical planes along the curves with various trajectories while making oscillating and arc-like multi-axis movements when it is in a constant active balanced state in relation to the vertical and horizontal axes.

2. The device to make a relief surface, which contains;
a driven mobile frame installed on a motionless chassis and program controlled;
a drive for the feeding mechanism;
a cutting tool installed on a mobile frame that contains cutters differs because:
it has horizontal and vertical support pillars installed on a motionless chassis;
a program controlled mechanism to form the width of the stock that has a drive to adjust its position;
a mechanism to form stock edges that has a drive to adjust its position;
hold-down mechanisms;
an adjustable spring-loaded chain mechanism that is kinematically connected to the mechanism of the spring-loaded feeding rollers to move stock;
a device installed on a horizontal support pillar to move the mobile frame horizontally;
a device installed on a vertical support pillar to move the mobile frame vertically;
a device to move horizontal and vertical support pillars at an angle around the vertical axis for five-axis processing where the cutting tool is installed at the free end of the mobile frame and consists of a cutter shaft, an end mill or a laser that is connected to the electric motor by means of (for example) a belt transmission;
a mechanism, that adjusts and locks position, to form the width of the stock that contains a holder of the cutters connected to the electric motor;
a mechanism, that can adjust and lock position, to form stock edges that contains a holder of the figure cutters connected to the electric motor;
a hold-down mechanisms installed before and after the cutting tool that contain spring-loaded rollers that have the ability to self-adjust as the stock of various thicknesses moves.
mechanisms of the spring-loaded feeding rollers to move stock that contain spring-loaded bottom and top support pillars with constant tension, bearing axles with chain sprockets of the chain mechanism and located on them leading and holding down rollers that provide stable hold down to the surface of stock of various thicknesses;
bottom support pillars that can adjust and lock position in relation to the top support pillars;
a device for horizontal movement of the mobile frame that contains a ball-screw with the link connected to the motor via a ball-joint installed on the free end carries the element to effect the mobile frame in the horizontal plane,
a device for vertical movement of the mobile frame that contains a ball-screw with the link connected to the motor via a ball-joint installed on the free end carries the element to effect the mobile frame in the vertical plane,
where the mobile frame is installed on a motionless chassis on opposing vertical and horizontal axes providing for the movement of the cutting tool in horizontal and vertical axes along the curves with various trajectories while making multi-axis oscillating arc-like movements while maintaining the active balanced state of the frame in relation to the vertical and horizontal axes;
the drive of the mechanism to feed stock that is constructed so that it can adjust the speed of the stock feeding to apply infinite numbers of patterns.

3. Device described in claim 2 differs in that the stock can have (for example) elliptical, circular, hexagonal, square, octagonal, or rectangular cross sections.

4. Device described in claim 2 differs in that the stock can be flat or disk shaped and secured on a rotary table. In this case a stock feeding is a revolving of the stock on its axis.

5. Device described in claims 2 differs in that the cutting edge of the figure cutters to form stock edges can be (for example) a rectilinear section, opposing arc-like sections and a rectilinear section with the smaller dimension lengthwise width that are smoothly linked, or arc-like section and a linear section with the reduced lengthwise width that are smoothly linked, or linear terraced sections smoothly linked, or symmetrically located linear section along the longitudinal axis with alternating pits.

6. Device described in claims 2 is differs in the cutting edge of the one-piece figure cutters installed on the cutter shaft contains (for example), linear and serrated sections on one side and linked lengthwise arc-like, linear and serrated sections on the opposite side, or linked sinusoidal sections on one side and linked linear and arc-like sections on the opposite side.

7. Device described in claims 2 differs in that the cutting edge of the sectional cutters installed on the cutter shaft contains (for example) a convex section with an overhang on the face plane, or a triangular section, or a shifted convex section, or a triangular section with the teeth at the top, or a convex slanted section, or a sinusoidal section with concave and linear sections.

8. Device described in claim 2 differs in that wood, stone, metal, plastic, foam, and other materials can be used as stock material.

9. A powered contour shaping machine comprising:
a cutting tool which is movable for material removal; a motor coupled to the cutting tool for powering the cutting tool for material removal; and
a support arm pivotable about a generally horizontal pivot axis, the support arm supporting the cutting tool with a cutting tool moment arm on a first side of the pivot axis, the support arm supporting the motor with a motor moment arm on a second, opposing side of the pivot axis, wherein cutting tool moment arm and the motor moment arm are selected on the support arm so the motor gravitationally balances and offsets the cutting tool.

10. The powered contour shaping machine of claim 9, wherein the motor is coupled to the cutting tool with a belt or chain.

11. The powered contour shaping machine of claim 9, further comprising:
a computer controlled actuator for controlling pivoting of the support arm about the pivot axis.

12. The powered contour shaping machine of claim 11, wherein the actuator comprises:
a computer controlled motor which controllably rotates a shaft;
a couple threadedly received on the shaft for linear movement along the shaft; and
a link connecting the couple to the support arm.

13. The powered contour shaping machine of claim 9, wherein the support arm is further pivotable about a generally vertical axis for lateral positioning.

14. The powered contour shaping machine of claim 12, further comprising:
a computer controlled actuator for controlling pivoting of the support arm about the generally vertical axis for lateral positioning.

15. The powered contour shaping machine of claim 9, further comprising:
a powered stock feed apparatus for moving stock relative to the cutting tool.

16. A powered contour shaping machine, comprising:
a cutting tool for material removal;
a support arm pivoting about a first pivot axis and about a second pivot axis generally perpendicular to the first pivot axis, the support arm supporting the cutting tool on a first side of the first pivot axis, the support arm supporting a counterweight on a second, opposing side of the first pivot axis so the counterweight gravitationally offsets the cutting tool;
a first, computer controlled actuator for controlling pivoting of the support arm about the first pivot axis;
a second, computer controlled actuator for controlling pivoting of the support arm about the second pivot axis; and
a powered stock feed apparatus for moving stock relative to the cutting tool.

17. The powered contour shaping machine of claim 16, wherein the cutting tool is a laser, or an end mill.
